(19) United States
(12) Patent Application Publication
(10) Pub. No.: US 2021/0108461 A1
(43) Pub. Date: Apr. 15, 2021

(54) FIREPROOF SHUTTER THAT OPENS AND CLOSES WITHOUT POWER

(71) Applicant: Seong Bae KANG, Seoul (KR)

(72) Inventor: Seong Bae KANG, Seoul (KR)

(21) Appl. No.: 17/070,279

(22) Filed: Oct. 14, 2020

(30) Foreign Application Priority Data
Oct. 15, 2019 (KR) 10-2019-0127830

(51) Int. Cl. E06B 9/17; A62C 2/22

(52) U.S. Cl. CPC E06B 9/17007; E06B 2009/17069; A62C 2/22

(57) ABSTRACT

The present disclosure provides a non-powered open/close fireproof shutter including a shutter, a shutter track which is disposed in a horizontal direction and guides both end portions of the shutter in a width direction, a coil box in which a winding shaft for winding the shutter is installed to store the shutter in a coil form, a winding motor which rotates the winding shaft, and a weight which is connected to the shutter and deploys the shutter stored in the coil box along the shutter track. The non-powered open/close fireproof shutter according to the present disclosure can significantly reduce initial facility investment and maintenance costs, prevents malfunction of the fireproof shutter, which may occur when power is lost due to a loss of an emergency power source, in advance, and can secure reliability of a fire blocking function.

### CROSS-REFERENCE TO RELATED APPLICATIONS

Priority to Korean patent application number 10-2019-0127830 filed on Oct. 15, 2019 the entire disclosure of which is incorporated by reference herein, is claimed.

### BACKGROUND OF THE DISCLOSURE

### Field of the Disclosure

The present disclosure relates to a non-powered open/close fireproof shutter, and particularly, a horizontal type non-powered open/close fireproof shutter which is installed in a vertical penetration type building.

### Related Art

In recent years, with diversification of buildings, multi-story buildings divide separate and independent spaces on the same floor, and in consideration of efficient space utilization, a building such as an apartment or shopping center which include a so-called courtyard having a space formed therein to vertically penetrate has been increased.

When a fire occurs in the vertical penetration type building, a phenomenon in which the fire rapidly spreads to high floors occurs due to a chimney phenomenon. Accordingly, a horizontal type fire shutter should be installed on each floor in the vertical through-type building.

However, in a horizontal type fire shutter of the related art, an emergency power source is applied to the shutter when afire occurs, and the shutter is deployed according to an operation of an electric motor. In this way, in the electric drive type fireproof shutter, the separate emergency power source is required. Accordingly, an installation cost and a maintenance cost increase, the fireproof shutter is not properly operated when power is lost due to a loss of the emergency power source or the like, and thus, an original function for blocking fire may be lost.

### SUMMARY OF THE DISCLOSURE

An object of the present disclosure is to provide a non-powered open/close fireproof shutter which can be opened or closed without separate power such as electric power.

According to an aspect of the present invention, there is provided a fireproof shutter including: a shutter; a shutter track which is disposed in a horizontal direction and guides both end portions of the shutter in a width direction; a coil box in which a winding shaft for winding the shutter is installed to store the shutter in a coil form; a winding motor which rotates the winding shaft; and a weight which is connected to the shutter and deploys the shutter stored in the coil box along the shutter track.

The fireproof shutter may further include a traction wire which is connected to the shutter; and a pulley which is disposed between the shutter and the weight and supports the traction wire in a roll manner.

The shutters may be provided in a pair so that the shutters are each deployed in directions opposite to each other, and the coil boxes, the winding motors, the traction wires, and the pulley may be provided in a pair to correspond to the pair of shutters, respectively.

The weights may be together connected to the pair of traction wires.

The weights may be provided in a pair and are respectively fastened to the pair of traction wires.

The shutter track may include a first shutter track which is disposed in a horizontal direction, a second shutter track which is curved from the first shutter track, and a third shutter track which extends in a vertical direction from the second shutter track.

The pulley may be installed in a composite pulley method so that a transport distance of the shutter increases by a multiple of a transport distance of the weight.

The shutter may be provided so that a steel shutter and a fireproof screen are alternately connected to each other.

The fireproof shutter according to the present disclosure can significantly reduce initial facility investment and maintenance costs.

In addition, the fireproof shutter according to the present disclosure prevents malfunction of the fireproof shutter, which may occur when power is lost due to a loss of an emergency power source, in advance, and can secure reliability of a fire blocking function.

### BRIEF DESCRIPTION OF THE DRAWINGS

FIG. 1 is a perspective view schematically illustrating a fireproof shutter according to a first embodiment of the present disclosure.

FIG. 2 is a cross-section view illustrating the fireproof shutter according to the first embodiment of the present disclosure.

FIG. 3 is a cross-section view illustrating a fireproof shutter according to a second embodiment of the present disclosure.

FIG. 4 is a cross-section view illustrating a fireproof shutter according to a third embodiment of the present disclosure.

FIG. 5 is a cross-section view illustrating a fireproof shutter according to a fourth embodiment of the present disclosure.

### DESCRIPTION OF EXEMPLARY EMBODIMENTS

Terms or words used in the present specification and claims should not be construed as being limited to their usual or dictionary meanings, and based on a principle that the inventor may appropriately define concepts of terms in order to describe his own invention in the best way, the term or word should be interpreted as a meaning and concept that fits the technical idea of the present disclosure. Therefore, since configurations illustrated in embodiments and drawings described in the present specification are only embodiments of the present disclosure and do not represent all the technical ideas of the present disclosure, it should be understood that there may be various equivalents and modification examples which can replace the configurations.

Hereinafter, a fireproof shutter according to the present disclosure will be described with reference to the accompanying drawings.

### First Embodiment

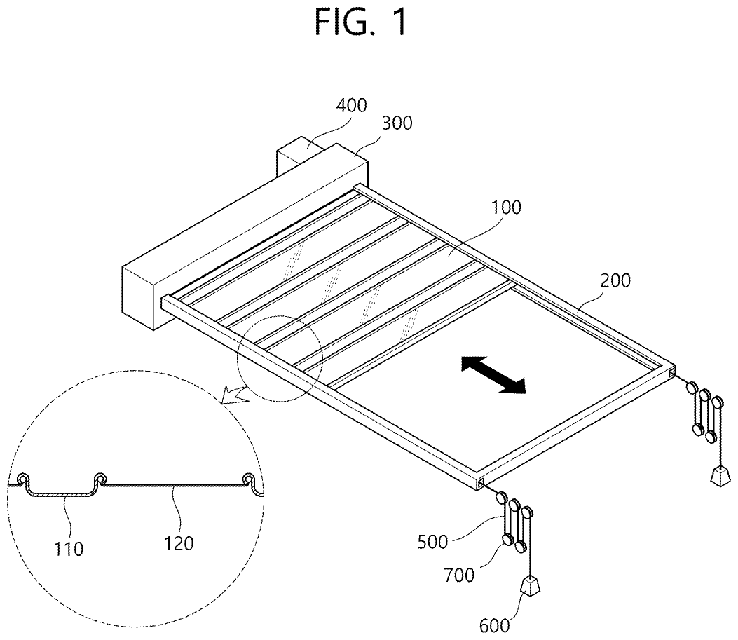

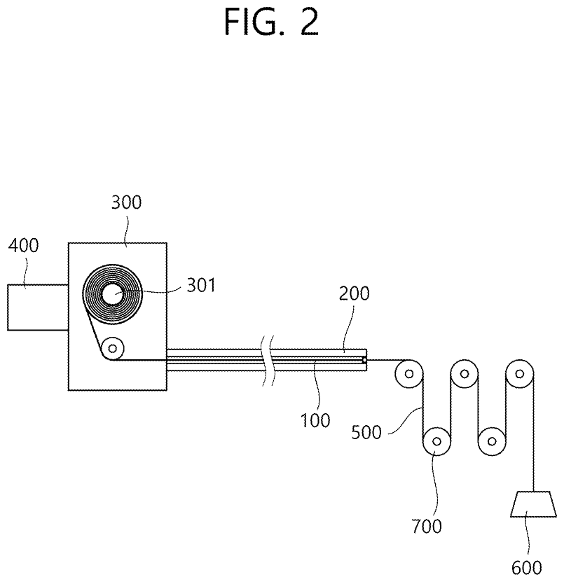

FIG. 1 is a perspective view schematically illustrating a fireproof shutter according to a first embodiment of the present disclosure, and FIG. 2 is a cross-section view illustrating the fireproof shutter according to the first embodiment of the present disclosure.

Referring to FIGS. 1 and 2, the fireproof shutter according to the first embodiment of the present disclosure may be configured to penetrate a courtyard of a building so as to block flames and smoke.

The fireproof shutter according to the first embodiment of the present disclosure may include a shutter 100, a shutter track 200, a coil box 300, a winding motor 400, a traction wire 500, a weight 600, and a pulley 700.

The shutter 100 may be formed of a material capable of satisfying fireproof and flameproof conditions. For example, the material of the shutter 100 may include a steel shutter and/or a fireproof screen made of silica fibers. The fireproof shutter according to the first embodiment of the present disclosure is in a form in which a steel shutter 110 and a fireproof screen 120 are alternately provided each other in order to harmonize durability of the steel shutter and light weight of the fireproof screen.

Both ends of the shutter 100 in a width direction are inserted into the shutter track 200. The shutter track 200 may guide opening and closing of the shutter 100. The shutter track 200 according to the first embodiment of the present disclosure is disposed in a horizontal direction so that the shutter 100 can be opened and closed in the horizontal direction.

A winding shaft 301 for winding the shutter 100 may be provided inside the coil box 300. The winding motor 400 may rotate the winding shaft 301 so that the shutter 100 can be stored in the winding shaft 301 in a coil shape.

One end of the traction wire 500 may be connected to the shutter 100, and the other end of the traction wire 500 may be connected to the weight 600. Preferably, the traction wire 500 is provided to have a sufficient length in consideration of a length of the shutter 100 when the shutter 100 is fully deployed and a length of the shutter 100 when the weight 600 can be lifted.

The pulley 700 is disposed between the shutter 100 and the weight 600. The pulley 700 supports the traction wire 500 in a roll manner. In emergencies, the weight 600 may have a weight which allows the shutter 100 to be released and deployed from the coil box 300 by the own weight of the weight 600.

Here, the pulley 700 may be provided to be modified in a fixed pulley method in which the pulley 70 is installed at a distal end of the traction wire 500. However, compared to the fixed pulley method, in order to increase a deployment distance of the shutter by multiples with only a short movement distance of the weight 600 in the direction in which the gravity is applied so that the deployment of the shutter 100 requiring a relatively long transport distance is realized, the fireproof shutter according to the first embodiment of the present disclosure may adopt a composite pulley method in which a plurality of pulleys are connected to each other.

As described above, the fireproof shutter according to the first embodiment of the present disclosure can deploy the shutter 100 disposed in the horizontal direction by the own weight of the weight 600 even when separate power is not supplied in emergencies.

Hereinafter, fireproof shutters according to other embodiments of the present disclosure will be described. In the following description, the same reference numerals are assigned to components similar to those of the fireproof shutter according to the first embodiment of the present disclosure described above, and detailed descriptions thereof will be omitted. Therefore, components for which detailed descriptions are omitted in the following description should be understood with reference to the above description.

### Second Embodiment

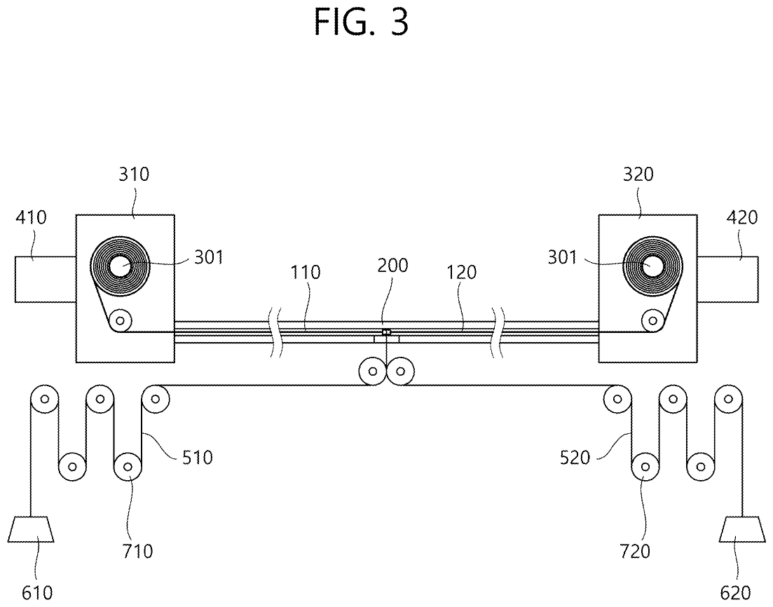

FIG. 3 is a cross-section view illustrating a fireproof shutter according to a second embodiment of the present disclosure.

Referring to FIG. 3, in the fireproof shutter according to the second embodiment of the present disclosure, the shutters 100 may be provided in a pair so that the shutters 100 can be respectively deployed in directions opposite to each other. The shutter 100 may be provided in a form separated into a first shutter 110 and a second shutter 120. According to this, the coil box 300, the winding motor 400, the traction wire 500, and the pulley 700 may be provided as a pair, respectively.

That is, the first shutter 110 is disposed to be deployed in a right direction of FIG. 3, and the second shutter 120 is disposed to be deployed in a left direction of FIG. 3. A first coil box 310 and a first winding motor 410 are disposed on a left side of the first shutter 110, and a first traction wire 510 is connected to a right end of the first shutter 110. A second coil box 320 and a second winding motor 420 are disposed on a right side of the second shutter 120, and a second traction wire 520 is connected to a right end of the second shutter 120.

A first weight 610 is connected to the first traction wire 510, and a second weight 620 is connected to the second traction wire 520. A first pulley 710 is disposed between the first shutter 110 and the first weight 610 to support the first traction wire 510 in a roll manner. A second pulley 720 is disposed between the second shutter 120 and the second weight 620 to support the second traction wire 520 in a roll manner.

As described above, in the fireproof shutter according to the second embodiment of the present disclosure, since the first shutter 110 and the second shutter 120 are respectively deployed in the directions opposite to each other, it is possible to more quickly close a fire zone in emergencies, and it is possible to close a relatively wide opening portion.

### Third Embodiment and Fourth Embodiment

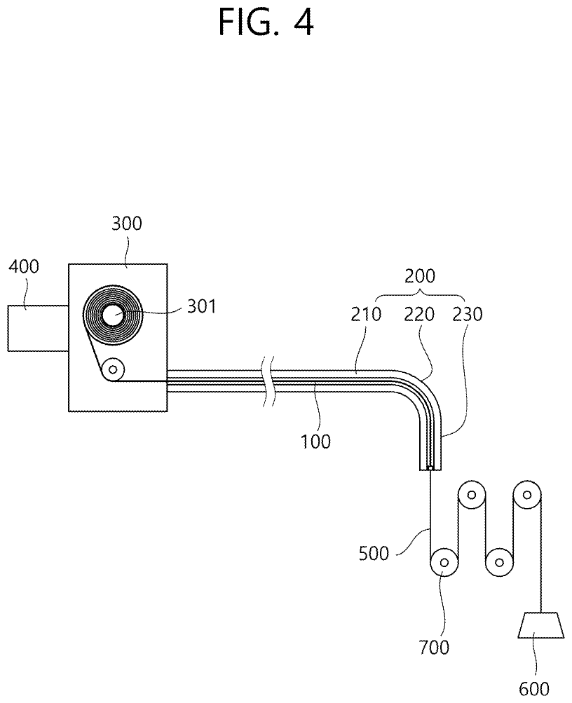

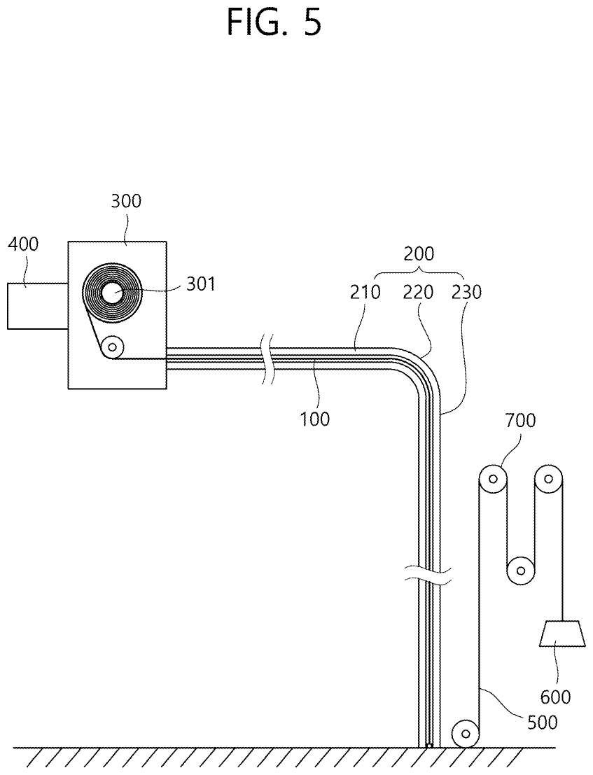

FIG. 4 is a cross-section view illustrating a fireproof shutter according to a third embodiment of the present disclosure, and FIG. 5 is a cross-section view illustrating a fireproof shutter according to a fourth embodiment of the present disclosure.

Referring to FIGS. 4 and 5, in the fireproof shutter according to the third embodiment of the present disclosure, the shutter 100 may close a fire zone in horizontal and vertical directions.

That is, a shutter track 200 may include a first shutter track 210 which is disposed in the horizontal direction, a second shutter track 220 which is curved from the first shutter track 210, and a third shutter track 230 which extends in the vertical direction from the second shutter track 220.

As described above, in the fireproof shutter according to the third embodiment, the shutter 100 can be deployed to extend in the horizontal and vertical directions, and thus, it is possible to effectively prevent flame from spreading in the vertical and horizontal directions.

Here, as illustrated in FIG. 5, in the third embodiment according to the present disclosure, the third shutter track 230 of the fireproof shutter may not extend to a floor surface according to an installation space, and thus, it is possible to prevent smoke from spreading along the shutter 100 when fire occurs. Moreover, when the third shutter track 230 extends to the floor surface, it is possible to completely block the fire zone.

The embodiments of the present disclosure described above and illustrated in the drawings should not be construed as limiting a technical idea of the present disclosure. A scope of protection of the present disclosure is limited only by matters described in claims, and a person having an ordinary knowledge in a technical field of the present disclosure can improve and change the technical idea of the present disclosure in various forms. Therefore, the modifications and changes will fall within the scope of protection of the present disclosure as long as it is self-evident to a person having an ordinary knowledge.

What is claimed is:

1. A fireproof shutter comprising:
a shutter;
a shutter track which is disposed in a horizontal direction and guides both end portions of the shutter in a width direction;
a coil box in which a winding shaft for winding the shutter is installed to store the shutter in a coil form;
a winding motor which rotates the winding shaft; and
a weight which is connected to the shutter and deploys the shutter stored in the coil box along the shutter track.

2. The fireproof shutter according to claim 1, further comprising:
a traction wire which is connected to the shutter; and
a pulley which is disposed between the shutter and the weight and supports the traction wire in a roll manner.

3. The fireproof shutter according to claim 2, wherein the shutters are provided in a pair so that the shutters are each deployed in directions opposite to each other, and
the coil boxes, the winding motors, the traction wires, and the pulley are provided in a pair to correspond to the pair of shutters, respectively.

4. The fireproof shutter according to claim 3, wherein the weights are together connected to the pair of traction wires.

5. The fireproof shutter according to claim 4, wherein the weights are provided in a pair, and are respectively fastened to the pair of traction wires.

6. The fireproof shutter according to claim 2, wherein the shutter track includes a first shutter track which is disposed in a horizontal direction, a second shutter track which is curved from the first shutter track, and a third shutter track which extends in a vertical direction from the second shutter track.

7. The fireproof shutter according to claim 6, wherein the pulley is installed in a composite pulley method so that a transport distance of the shutter increases by a multiple of a transport distance of the weight.

8. The fireproof shutter according to claim 1, wherein the shutter is provided so that a steel shutter and a fireproof screen are alternately connected to each other.
